(19) United States
(12) Patent Application Publication
(10) Pub. No.: US 2007/0260029 A1
(43) Pub. Date: Nov. 8, 2007

(54) Selective permeable polymer membrane for gases

(75) Inventors: Tadanori Koga, Stony Brook, NY (US); Miriam Rafailovich, Plainview, NY (US); Etsushi Akashige, Port Jefferson Station, NY (US)

Correspondence Address: THE FARRELL LAW FIRM, P.C., 333 EARLE OVINGTON BOULEVARD, SUITE 701, UNIONDALE, NY, 11553, US

(73) Assignee: The Research Foundation of the State University of New York, Stoney Brook, NY (US)

(21) Appl. No.: 11/711,526

(22) Filed: Feb. 27, 2007

Related U.S. Application Data
(60) Provisional application No. 60/777,044, filed on Feb. 27, 2006.

(51) Int. Cl. C08F 112/08

(52) U.S. Cl. 526/329.7; 526/347.2; 96/4

(57) ABSTRACT

Disclosed is a method and apparatus that contacts polymers with supercritical fluids in a density fluctuation ridge, producing selectively porous low-density regions impermeable to large molecule gases, for use in gas masks and respiratory processes.

### PRIORITY

This application claims priority to application Ser. No. 60/777,044, which was filed with the U.S. Patent and Trademark Office on Feb. 27, 2006.

### GOVERNMENT SUPPORT

The invention was supported, in part, by a grant from the National Science Foundation Materials Research Science and Engineering Center, Contract Number 1011182. The U.S. Government has certain rights in the invention.

### FIELD OF INVENTION

The present invention relates generally to selective permeable polymer membranes for gases, and more particularly to method and an apparatus that utilizes the effect of creating density fluctuations with supercritical fluids.

### SUMMARY OF THE INVENTION

When supercritical fluids contact polymers in a very narrow temperature and pressure region, referred to as the density fluctuation ridge, low density regions are produced in the polymer that are utilized to produce polymer thin films that become selectively porous only to small molecule gases. The materials are impermeable to large molecule gases, such as those involved in toxic attacks, complex molecules, bacteria and viruses, making the materials particularly useful in gas masks as well as to enhance respiratory processes.

In addition to providing a specific porosity of polymer membrane, the method of manufacture utilizes supercritical CO₂ (scCO₂), an environmentally friendly solvent that does not pose a workplace hazard.

### BRIEF DESCRIPTION OF THE DRAWINGS

For a better understanding of the invention, as well as other objects and further features thereof, reference is made to the following detailed description to be read in conjunction with the accompanying drawings, wherein:

FIGS. 1A and 1B are three dimensional surface topology images of an exposed polystyrene (PS) film and an unexposed PS film, respectively;

FIG. 2 shows temperature dependence for an unexposed free-standing PS thin film;

FIG. 3 shows time dependence of volume fraction of O₂ gas through the unexposed PS film;

FIG. 4 shows thickness dependence of permeability through unexposed PS films;

FIG. 5 shows oxygen permeability curves for exposed and unexposed PS films;

FIGS. 6A and 6B are charts of pressure dependencies of P₀ and S_{f}, respectively, for 150 nm thick exposed PS films;

FIGS. 7A and 7B are charts of thickness dependencies of P₀ and S_{f}, respectively;

FIG. 8 shows thickness dependencies of ratio of P₀ values for the PS films;

FIG. 9 is a chart of pressure dependencies of CO₂ gas permeability coefficients for exposed PS films;

FIG. 10 is a comparison of ratio of P₀ values for O₂ and CO₂ gases before and after exposure;

FIG. 11 shows pressure dependencies of Pₒ for exposed poly methyl methacrylate films with 150 nm initial thickness;

FIG. 12 shows molecular imprinting using a super critical fluid (SCF) process;

FIG. 13 shows relative permeability increases of PS films to O₂ and CO₂;

FIG. 14 is a schematic phase diagram of CO2; and

FIG. 15 is a schematic phase diagram of ethane, showing critical point (CP).

### DETAILED DESCRIPTION OF THE PREFERRED EMBODIMENTS

The following detailed description of preferred embodiments of the invention will be made with reference to the accompanying drawings. In describing the invention, explanation of related functions or constructions known in the art are omitted for the sake of clearness in understanding the concept of the invention, as such would obscure the invention with unnecessary detail.

In the present invention, the preferred embodiments utilize polymers of monodisperse hydrogenated polystyrene (PS, molecular weight (M_{w})=650 000) and poly methyl methacrylate (PMMA, M_{w}=105 000) obtained from Polymer Laboratories, both preferably having polydispersity indices of less than 1.05. PS thin films having thicknesses (L₀) ranging from 30 nm to 650 nm are spun cast on glass slides, with thicknesses of PMMA films fixed to 150 nm.

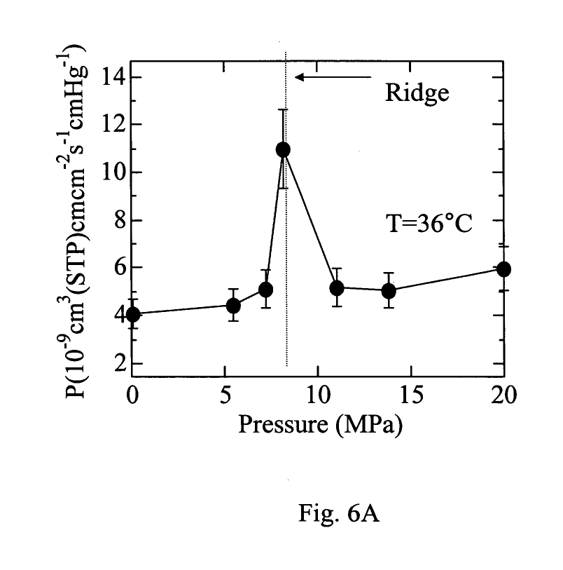

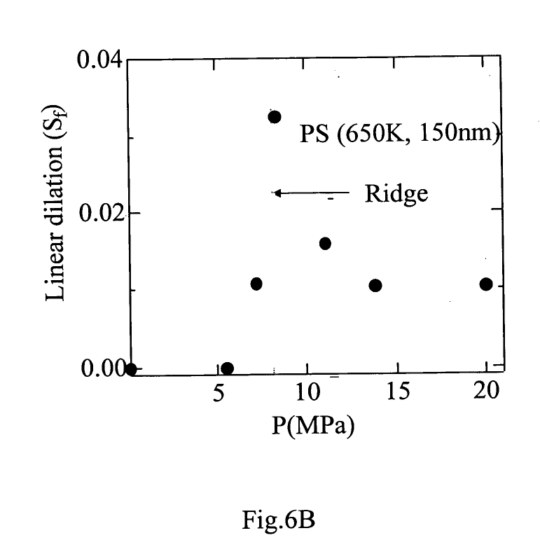

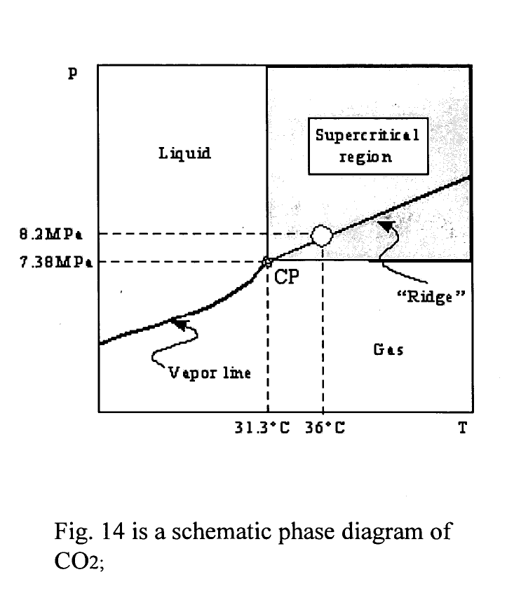

In a preferred embodiment, two sets of PS/PMMA films are prepared with different film thickness: one for scCO2 exposure and the other is for non-exposure, allowing comparison of results of films having the same film thickness. One sample of each thickness was floated onto deionized water and subsequently lifted onto a washer, preferably made of either aluminum plate or silicon wafer, with the polymer film covering the entire hole with a diameter of 4 mm. The second samples of each thickness were placed in supercritical CO₂ (scCO₂) prior to floating. To do this, the spun cast films were first placed in a high pressure chamber and immersed in scCO₂ at T=36° C. and different given CO₂ pressure conditions (0<P<20 MPa) for 2 hours, as shown in FIG. 14. As discussed in regard to FIG. 6, excess swelling occurs along the density fluctuation ridge, resulting in large degree of molecular scale porosity. The spun cast films are quickly depressurized to atmospheric pressure within 10 sec to verify the swelling structure. The vitrified films were then floated onto deionized water and subsequently lifted onto the washer. After the washer was allowed to dry, both unexposed and exposed free-standing films were subjected to various testing procedures including Atomic Force Microscopy (AFM) scans, gas permeability and ellipsometry measurements.

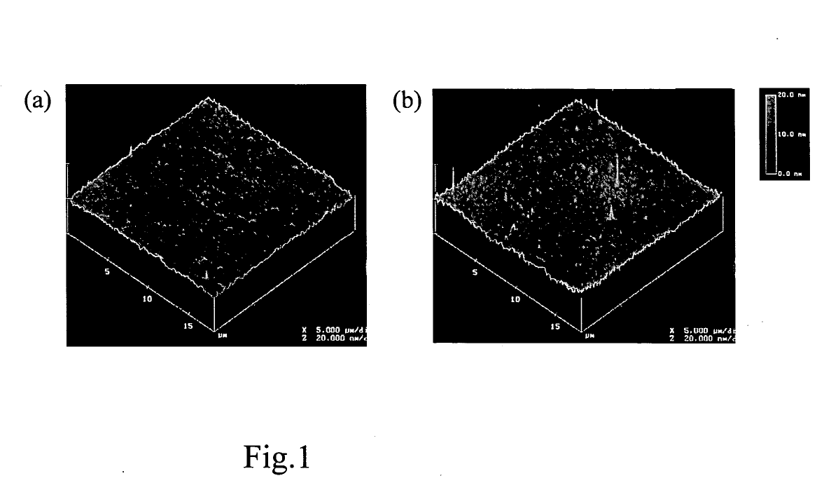

FIG. 1 shows AFM images of the surface topography for (a) a CO₂-treated PS free-standing film (L₀=150 nm) and (b) unexposed PS film prior to exposure in AFM experiments. The CO₂ conditions used was T=36° C. and P=8.2 MPa, which correspond to the density fluctuation ridge in the phase diagram of CO₂ where regions of low-density can be produced in the polymer films spun-cast on silicon substrates after completion of the above procedure. The density of the polymer films in the region of within ˜30 nm depth at the polymer/air interface can be reduced by more that 20%. This low-density formation can be achieved by the introduction of a large number of the molecular scale porosity, i.e. free volume, rather than by the formation of large voids during the quench process.

The AFM images of FIG. 1 confirm that large void structures do not form and that the surface remains flat even after exposure and subsequent floating. Hence, the film structures of the exposed free-standing film are preserved.

In regard to glass transition temperature, as mentioned above, the low-density formation is created by the introduction of the additional free volume at the polymer/air interface. The surface glass transition temperature (T_{g}) of the vitrified PS film, which is strongly related to the free volume, decreases by about 10° C. relative to that of bulk or without CO₂ exposure (T_{g}=100° C.). Measurement was made of the surface T_{g} of the exposed free-standing film with AFM mode, Shear Modulation Force Microscopy (SMFM). This technique is sensitive to the large change in viscoelastic behavior at air/polymer interface. PS film having a thickness of 150 nm was used and the heating rate from room temperature up to 120° C. was fixed to 1.0° C. per min.

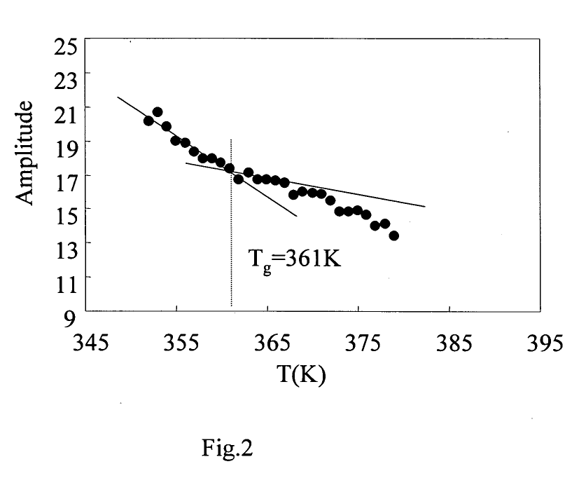

FIG. 2 shows the temperature dependence of the amplitude response of shear force (Δx) on a tip modulated parallel to the film surfaces with and without CO₂ treatment. The intersection of the two straight lines fitted to the data is identified as T_{g}. As shown in FIG. 2, the T_{g} value of the vitrified free-standing PS film decreased by about 10° C. relative to that of bulk or without CO₂ exposure (T_{g}=100° C.). This reduction in T_{g} was equivalent to that of the vitrified PS film before the floating, confirming again that the film quality including the free volume could be preserved even after the floating.

Ellipsometry experiments were performed in which the exposed and unexposed film thickness was measured by an ellipsometer (AutoE1-II). Permeability experiments were also performed. The density reduction described above is accomplished by the introduction of a large number of the molecular scale porosity, indicating that large flow of small molecules gases can go through the film. Measurements were taken of gas permeability of oxygen and carbon dioxide gases through the films. The washer covered with the polymer thin films was placed onto a LabPro™ O₂ gas detector and the percentage of O₂ gas that passes through the film was measured. An oxygen gas detector and LabPro™ interface (Verner Software and Technology) were used for real-time data collections. Since oxygen gas was utilized in air, the atmosphere of the chamber attached directly to the gas detector was initially filled with nitrogen gas. The hole of the washer was then placed over the hole of the chamber and the percentage of CO₂ gas that passed through the thin film was measured as a function of time.

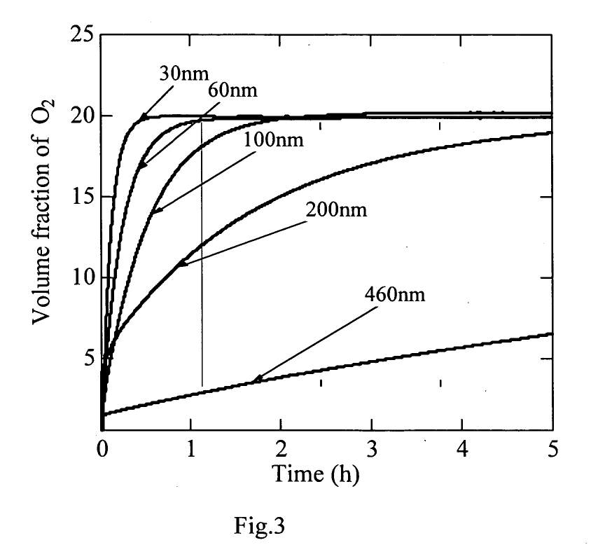

FIG. 3 shows representative results in terms of the change of the O₂ concentration with time for the unexposed PS film with L₀=150 nm. The permeability measurements were carried out as T=20° C. The time dependence of the 0₂ concentration Ø(t) could be approximated by the exponential function provided in Equation (1):
Ø=α−βexp(−t/τ) (1)

Where α and β are constants, and t is a time constant. τ is reversely proportional to the intrinsic permeability coefficient (P₀), such as shown in Equation (2):
τ=VL₀/P₀A (2)

In Equation (2), V is the volume of the chamber, A is the surface area and L₀ is the initial film thickness. τ values increase with film thickness.

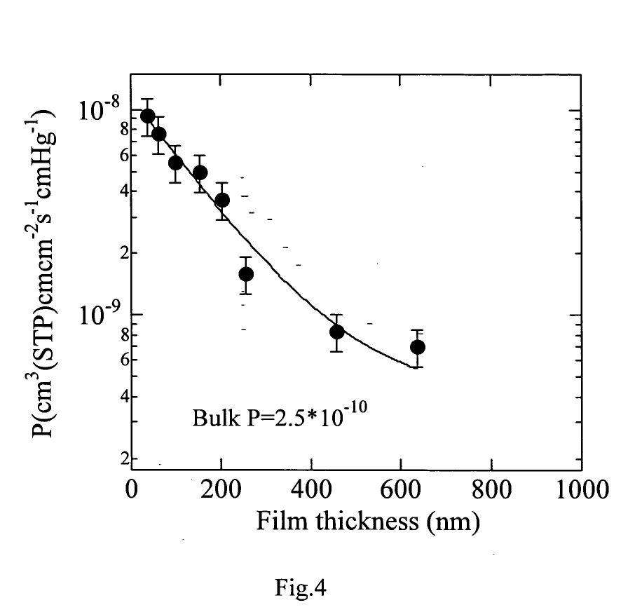

FIG. 4 shows the thickness dependence of the P₀ values for the unexposed PS2 films, based on the best fit of Equation (1) to the Ø(t) curves. To compare to the bulk P₀ values of the preferred embodiment, a unit of cm³ (STP) cmcm⁻²s⁻¹cmHg⁻¹ for the P₀ value was used, and P₀ can be expressed as shown in Equation (3):

$${P}_{0} = \frac{273}{T} \frac{V}{A} \frac{{L}_{0}}{τ} \frac{1}{76} \qquad ( 3 )$$

In Equation (3), T is absolute temperature used for the experiments. From FIG. 4, it can be seen that the P₀ values increase with decreasing the film thickness exponentially. Extrapolation to L₀→∞ gives the P₀ value of 4.0×10⁻¹⁰ (cm³ (STP) cmcm⁻²s⁻¹cmHg⁻¹)), which is close to the P₀ value of 0₂ gas for bulk PS (P₀=2.5×10⁻¹⁰ (cm³ (STP) cmcm⁻²s⁻¹cmHg⁻¹)), demonstrating that the methodology is reliable for measuring permeability of polymer thin films, and that the permeability coefficients of the PS thin films are much larger than the bulk value even without CO₂ treatments. For polymer films, the route for O₂ gas diffusion through the films is the molecular scale porosity, i.e. free volume, so that that increase in P₀ indicated that free volume changes with the film thickness.

FIG. 4 shows thickness dependence of permeability through unexposed PS films, in which behavior is described by exponential function of Equation (4):
P₀(T=36° C.,P=8.2 MPa)=4.0726*10⁻¹⁰+1.1238*10⁻⁸exp(−0.006882L₀) (4)

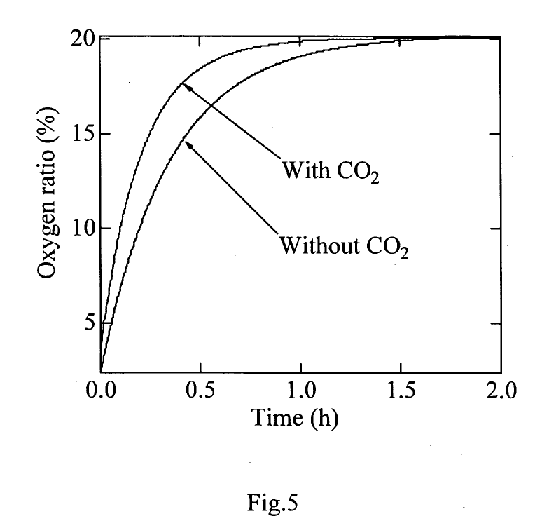

FIG. 5 demonstrates how exposure to CO₂ affects the Ø(t) curve of CO₂ gas through the PS film. The CO₂ condition used was T=36° C. and P=8.2 MPa. The unswollen film thickness was 150 nm. FIG. 5 shows that the 0₂ gas flow significantly increases after exposure to scCO₂. Based on the best fits to the data using Equations 1-3, the P₀ value with the CO₂ treatment was estimated to be 1.1×10⁻⁸ (cm³(STP) cmcm⁻²s⁻¹cmHg⁻¹), which was about three times larger than that of the unexposed film (P₀=4.0×10⁻⁹ (cm³ (STP) cmcm⁻²s⁻¹cmHg⁻¹)). Hence, exposure to scCO₂ further increases the permeability of 0₂ gas through the polymer thin films. Interestingly, the P₀ value exposed at the ridge is about 40 times larger than the bulk P₀ value.

FIG. 6A summarizes the effect of the CO₂ pressure on the P₀ values at T=36° C. FIG. 6A shows that CO₂ exposure increases the P₀ values in the whole pressure range used, compared to that of the unexposed film. In addition, a sharp maximum appears at the density fluctuation ridge (P=8.2 MPa) in the P₀ vs. P plot, indicating that the polymer film is most porous and permeable at this point.

FIG. 6B shows the pressure dependence of the linear dilation of the vitrified films.

The linear dilation was calculated from the equation S_{f}=(L−L₀)/L₀, where L and L₀ are the measured thickness of the swollen and unswollen polymer thin films, respectively. As shown, P₀ and S_{f} values strongly correlate each other and formation of the low-density region is accomplished by introducing a large number of the molecular scale porosity to enhance the flow of 0₂ gases through the film. Consequently, in a preferred embodiment, the permeability of 0₂ gas is controlled by tuning the swelling ratio of polymer thin films.

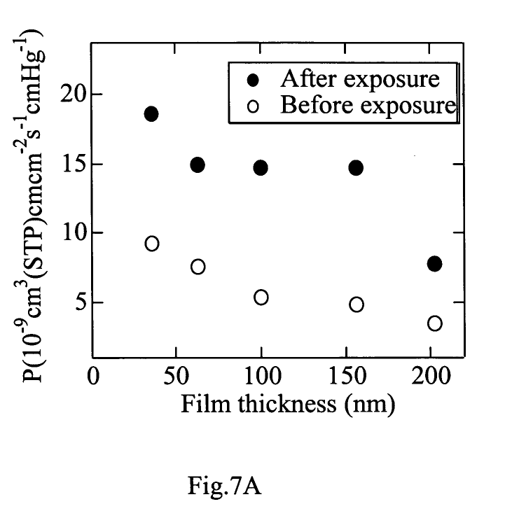

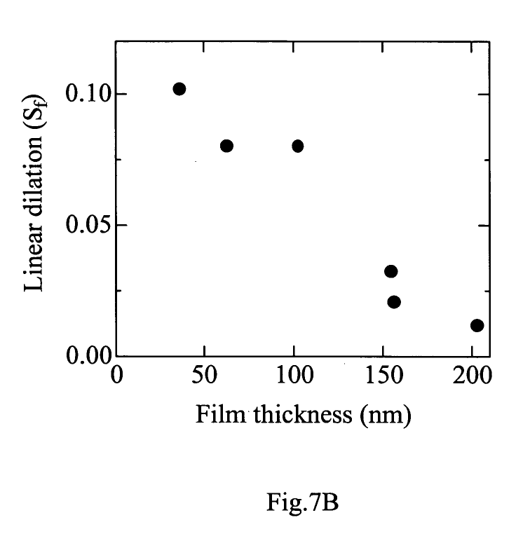

Further focusing on P₀ for the PS films exposed to CO₂ at the ridge, FIGS. 7A and 7B chart the thickness dependencies of P₀ and S_{f}, respectively, for PS films with CO₂ exposure at T=36° C. and P=8.2 MPa. FIG. 7A shows the thickness dependence of P₀ for 0₂ gas through the PS films exposed at the ridge. As for the unexposed films, the P₀ values increased with decreasing the film thickness. Specifically, for the thinnest film (L₀=36 nm) studied among the preferred embodiments, the P₀ value reached P₀=2×10⁻⁸ (cm³ (STP) cmcm⁻²s⁻¹ cmHg⁻¹), which corresponds to the P₀ value for an empty holder. Therefore, a preferred embodiment utilizes a low-density ultra thin PS films as a membrane.

FIG. 7B shows the thickness dependence of S_{f} for the exposed films, providing that the P₀ values depend on the linear dilation of the films, as indicated above. This behavior in P₀ vs. L₀, i.e., S_{f} decreased with increasing the film thickness, demonstrates that the anomalous linear dilation enhanced by the density fluctuation is a surface effect.

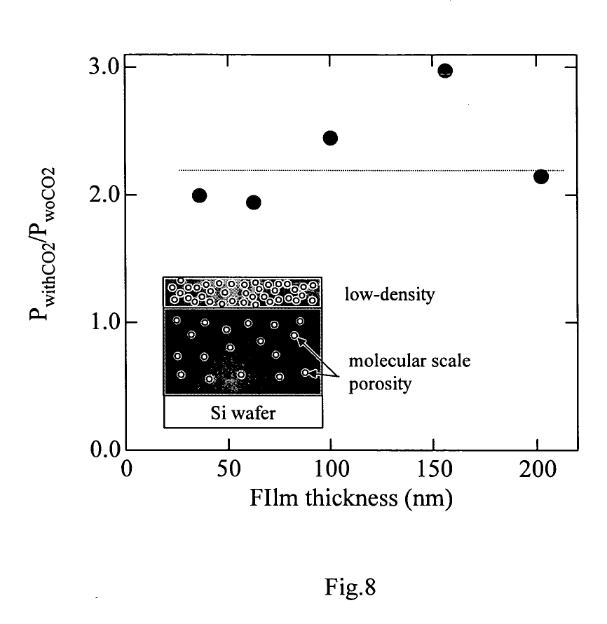

FIG. 8 shows the ratio of the P₀ values for the exposed films relative to those for the unexposed films. FIG. 8 shows that the scCO₂ treatment increases the P₀ values by a factor of about 2.5 irrespective to the film thickness used in this study. This is consistent with our previous results showing that a region of effective low-density formation occurs only within ˜30 nm at the polymer/air interface and then decays into the bulk.

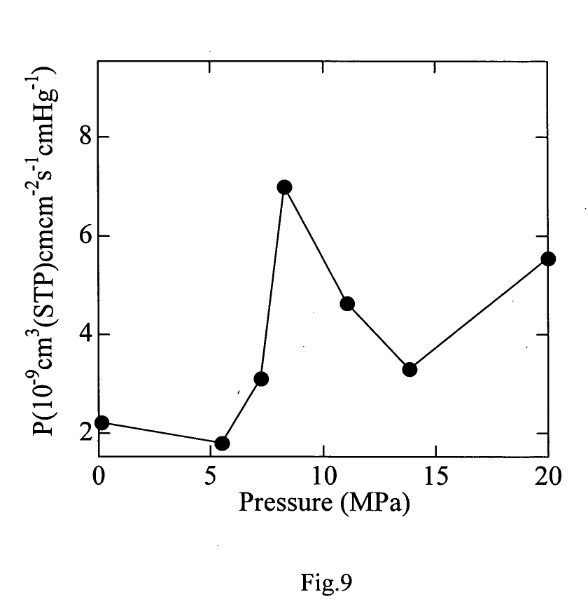

FIG. 9 shows the P₀ values for CO₂ gas through the exposed PS films. FIG. 9 shows permeability behavior to be a function of scCO₂ pressure. Since the size of both O₂ and CO₂ gases are commensurate to that of the free volumes, the exposed PS film is also effective for CO₂ gas as a high permeability membrane.

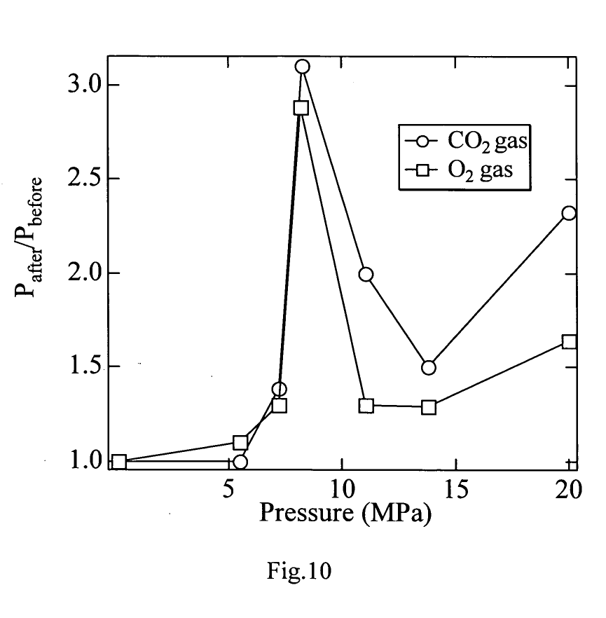

FIG. 10 compares the ratios of P₀ before and after exposure for O₂ and CO₂ gases. FIG. 10 clearly shows that the effect of scCO₂ exposure in the excess increase in P₀ is almost identical for both O₂ and CO₂ gases. Again, the maximum enhancement in P₀, i.e., about 3 times larger that the unexposed film, could be achieved at the density fluctuation for both gases.

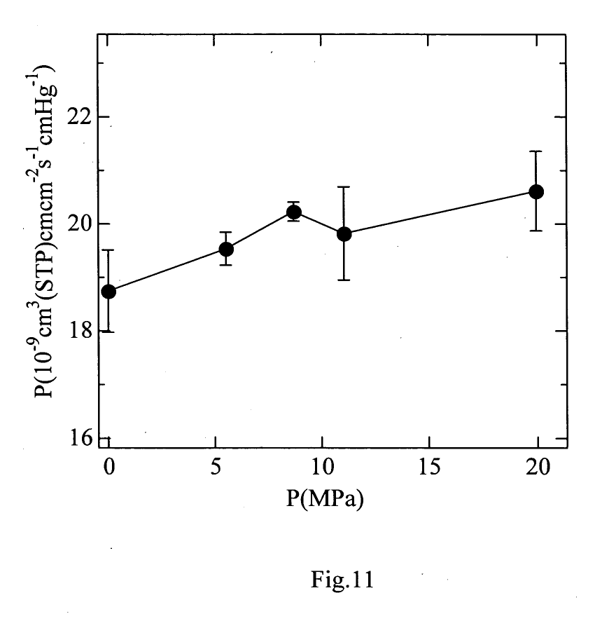

FIG. 11 shows the pressure dependence of the P₀ values of O₂ gas through the exposed PMMA thin films. The original film thickness was fixed to 150 nm. An enhancement in the P₀ values is seen compared to the bulk PMMA P₀=2.5×10⁻¹⁰ (cm³ (STP) cmcm⁻²s⁻¹ cmHg⁻¹)). The P₀ values at the higher pressure tend to become larger that that at the ridge, while the P₀ value showed the maximum at the ridge for the exposed PS films. This pressure dependence of P₀ is in good agreement with the report in situ swelling behavior of the PMMA this films in CO₂ in which S_{f} increased with increasing pressure even after passing the ridge.

Hence, as for the exposed PS films, the enhancement in P₀ depends on the swelling ratio, in turn, the volume fraction of free volumes introduced by the exposure. It should be added that the P₀ values for the exposed PMMA films were much larger then those for the exposed PS thin films having the same original film thickness, indicating that PMMA plays a role as a more permeable membrane.

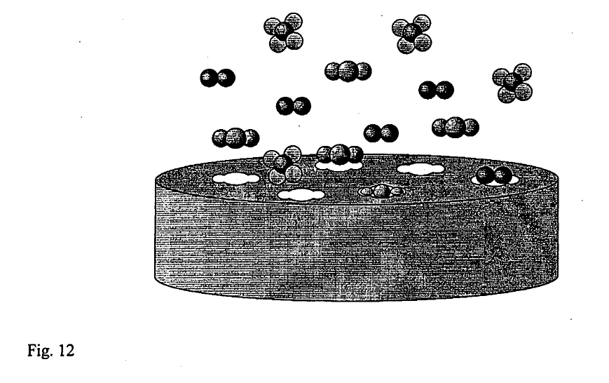

As shown in FIG. 12, an exposed polymer film has large degree of molecular scale porosity, which can be selectively occupied by the same gas molecules used for the SCF process, resulting in a larger flow of the target gas through the membrane.

Since the process involves molecular level porosity and rapid vitrification, an investigation was performed regarding whether actual molecular templating occurs. In addition to improved size dependent separation, i.e. virus vs. gas, a chemical specificity was also patterned, for identification and blocking of toxic gases, as shown in FIG. 12.

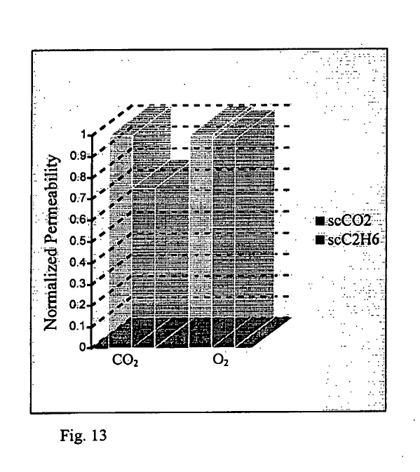

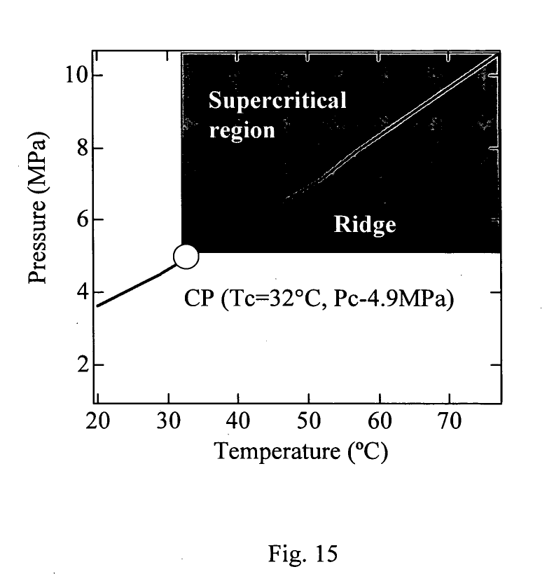

In a preferred embodiment, a thick PS film was exposed to both scCO₂ and supercritical ethane gas under respective ridge conditions, as described in FIG. 15, using conditions of T=37.2° C. and P=5.4 MPa for supercritical ethane, corresponding to the density fluctuation ridge. For scCO2, the same condition described above (T=36.0° C. and P=8.2 MPa) was used. Measurement was made of permeability coefficients of the two films for O₂ and CO₂ gases. The results shown in FIG. 13 normalize the magnitude of permeability by that for the PS film exposed to scCO₂.

FIG. 13 shows that the permeability for O₂ is independent of the supercritical gas exposure, which is consisted with in situ neutron reflectivity data showing that linear dilation of the films was independent of the supercritical fluids used, as long as the magnitude of the density fluctuations of supercritical fluids is identical. In contrast, a significant enhancement in permeability for CO₂ gas occurs in the membrane imprinted with scCO₂. Since CO₂ and O₂ are molecules of comparable size, this result suggests a molecular templating effect where details of the molecular structure are important in permeability.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed:

1. A method for producing polymers, the method comprising:
contacting the polymer with a supercritical fluid in a density fluctuation ridge,
wherein contact with the supercritical fluid creates a selectively porous low density region.

2. The method of claim 1, wherein the density fluctuation ridge includes a pressure region.

3. The method of claim 2, wherein the density fluctuation ridge further includes a temperature region.

4. The method of claim 1, wherein a low-density region created by the density fluctuation ridge is impermeable to large molecule gases.

5. The method of claim 1, wherein the method selectively creates a low-density region porous to select small molecule gases.

6. The method of claim 5, wherein the selectively created porous low-density region exhibits a permeability behavior that is a function of scCO₂ pressure.

7. The method of claim 1, further comprising:
placing spun cast films in a high-pressure chamber and immersing the spun cast films in supercritical fluids at a set temperature and differing CO₂ pressure conditions.

8. The method of claim 7, wherein the pressure conditions vary between zero and 20 MPa.

9. The method of claim 7, wherein the pressure is 8.2 MPa.

10. The method of claim 1, wherein the supercritical fluid is an environmentally friendly solvent.

11. A filtration apparatus comprising:
a polymer that is selectively porous to small molecule gases via treatment by contacting the polymer with a supercritical fluid in a density fluctuation ridge, wherein contact with the supercritical fluid creates a selectively porous low density region.

12. The filtration apparatus of claim 1, wherein the filtration apparatus is a gas mask.
